(19) United States
(12) Patent Application Publication
(10) Pub. No.: US 2007/0288269 A1
(43) Pub. Date: Dec. 13, 2007

(54) System and method for automated management of replacement building projects in a disaster relief area

(75) Inventors: Robert Vernon McLemore, Charlotte, NC (US); Christine M. Carriker, Indian Trail, NC (US)

Correspondence Address: OSTROLENK FABER GERB & SOFFEN, 1180 AVENUE OF THE AMERICAS, NEW YORK, NY, 100368403, US

(73) Assignee: HouseRaising, Inc.

(21) Appl. No.: 11/729,022

(22) Filed: Mar. 28, 2007

Related U.S. Application Data
(60) Provisional application No. 60/786,855, filed on Mar. 29, 2006.

(51) Int. Cl. G06Q 40/00

(52) U.S. Cl. 705/4

(57) ABSTRACT

The invention provides a system and method for using a database to rebuild a damaged or destroyed building. In particular, user contact information is received and stored in a database that represents a party owning the damaged or destroyed building. Further, pre-damaged discovery information is stored that represents features of the damaged or destroyed building and features of a building site of the damaged or destroyed building. Replacement building information is also received and stored that represents features for a replacement building that correspond with the damaged or destroyed building. In addition, foundation upgrade information is collected that represents a desired modification to be made to the building site. Thereafter, site inspection information is received that represents observations made during a physical inspection of the building site of the damaged or destroyed building, and the replacement building information can be modified according to foundation upgrade information, the site inspection information, and financial information that is received and stored. Replacement building plans are generated and a binding sales contract for the party and a builder is also generated for the replacement building.

### CROSS-REFERENCE TO RELATED APPLICATIONS

This patent application is based upon and claims priority to U.S. provisional patent application Serial No. 60/786,855, filed Mar. 29, 2006, entitled SYSTEM AND METHOD FOR AUTOMATED MANAGEMENT OF REPLACEMENT BUILDING PROJECTS IN A DISASTER RELIEF AREA, the entirety of which is incorporated herein by reference.

### BACKGROUND OF THE INVENTION

1. Field of the Invention

The present invention relates generally to building construction, and, more particularly, to replacing building structures damaged or destroyed in a disaster relief area.

2. Description of the Related Art

Large-scale disasters occur for various reasons, strike at any time, and can wreak havoc for thousands and even millions of people. Recently, for example, natural disasters such as hurricanes, earthquakes, tsunamis and fires, in addition to man-made disasters, such as terrorist attacks and industrial accidents, have collectively left hundreds of thousands of people homeless.

The costs and logistics of assessing and replacing building structures that are damaged or destroyed during a disaster are enormous and daunting. In a recent estimate in the Shreveport Times (www.shreveporttimes.com), over two hundred and fifteen thousand homes in the state of Louisiana alone were destroyed by Hurricane Katrina. Many thousands of people in the gulf coast region of America continue to wait for their damaged or destroyed homes to be assessed by insurance agencies and replaced in accordance with insurance polices. Unfortunately, prior art methods of assessing and replacing destroyed residential buildings in the wake of a disaster is expensive and often painfully slow.

One reason for such shortcomings in the prior art is that, typically, a high-level (i.e., above the ground) analysis of a land area that has suffered damage due to a disaster is performed long before individual building sites are assessed for damage. This contributes to delays in assessing and replacing buildings, such as residential buildings, damaged in a disaster.

FIG. 1 is a block diagram illustrating an example known arrangement 100 of parties to a custom rebuild or replacement home building project. As shown in FIG. 1, a builder 102 manages the building project and, as necessary, hires a plurality of subcontractors 104 to assist in the project. For example, one subcontractor 104 performs plumbing services, one subcontractor 104 performs electrical services, one subcontractor 104 performs heating and ventilation services, and one subcontractor 104 performs masonry services. Homeowner 106 is the purchaser of the rebuilding or replacement home project.

As known in the art and illustrated in FIG. 1, builder 102, subcontractors 104 and homeowner 106 each purchase one or more insurance policies 108. For example, builder 102 may purchase general liability insurance, casualty insurance and/or workman's compensation insurance policies 108. Subcontractors 104 also purchase insurance policies 108, and homeowner 106 purchases a buyer's insurance policy 108. Although the parties to building project, in accordance with the prior art are related by the project, typically, they do not purchase insurance policies from the same insurance provider. Therefore, a tremendous amount of overhead costs is incurred in a typical prior art arrangement. Moreover, the arrangement 100 illustrated in FIG. 1 represents a partial view, as many more subcontractors and other parties, such as described in greater detail in commonly assigned, co-pending U.S. patent application, Ser. No. 11/029,569. Further, when multiplied by hundreds or thousands of building projects, the overhead costs associated with insurance policies are extremely high.

### SUMMARY OF THE INVENTION

The present invention enables a prompt, accurate and improved system and method for gathering factual data in order to assess a destroyed or damaged building. In a preferred embodiment, the invention comprises an internet-based software application that enables a user to submit information related to insurance claims. For example, insurance companies, banks and government agencies use the present invention to submit and review claims-related information, particularly for buildings.

In one embodiment, the invention provides a system and method for using a database to rebuild a damaged or destroyed building that was damaged or destroyed during a disaster. In particular, user contact information is received and stored in a database that represents a party owning the damaged or destroyed building. Further, pre-disaster discovery information is stored that represents features of the damaged or destroyed building and features of a building site of the damaged or destroyed building. Replacement building information is also received and stored that represents features for a replacement building that correspond with the damaged or destroyed building. In addition, foundation upgrade information is collected that represents a desired modification to be made to the building site. Thereafter, site inspection information is received that represents observations made during a physical inspection of the building site of the damaged or destroyed building, and the replacement building information can be modified according to foundation upgrade information, the site inspection information, and financial information that is received and stored. Replacement building plans are generated and a binding sales contract for the party and a builder is also generated for the replacement building.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a block diagram showing a known arrangement of parties associated with replacement of building projects in a disaster relief area;

FIG. 2 is a diagram illustrating a hardware arrangement including devices associated with a preferred embodiment of the present invention;

FIG. 3 is a block diagram of the functional elements of a network connecting device used in accordance with the present invention;

FIG. 4 shows a block diagram arrangement of parties in accordance with a preferred embodiment of the present invention;

FIG. 5 is flow chart illustrating steps associated with submitting and retrieving information related to replacement of buildings;

FIG. 6 is an example internet home page provided to a user;

FIG. 7 shows an example display screen that is operable for a user to select a funding agent;

FIG. 8 shows an example display screen that is operable for a user to select a respective client of the funding agent selected in FIG. 7;

FIG. 9 illustrates an example display screen that identifies a particular client selected in the display screen shown in FIG. 8;

FIGS. 10A and 10B show display screens that provide contact information in connection with a previously selected client;

FIGS. 11A-11E show example display screens that identify data entry forms that, are presented to a user to submit information representing a client's previous home;

FIG. 12 shows an example display screen for a user to review options in connection with a home replacement or rebuilding project;

FIGS. 13A-13D illustrate example display screens for submitting/reviewing information regarding rebuilding a building structure;

FIGS. 14A and 14B illustrate example display screens for providing contracts in accordance with the present invention; and

FIGS. 15A-15F illustrate example display screens provided for a user to submit and/or review various legal materials.

### DETAILED DESCRIPTION OF EMBODIMENTS OF THE INVENTION

The present invention provides a quick means to gather factual data, as well as to organize and manage parties associated with replacing a building that is damaged or destroyed, for example, during a disaster.

The present invention preferably includes features described in commonly assigned and co-pending U.S. patent application, Ser. No. 11/029,569, filed on Jan. 5, 2005 and entitled SYSTEM AND METHOD FOR AUTOMATED MANAGEMENT OF CUSTOM HOME DESIGN AND BUILD PROJECTS, and in U.S. patent application Ser. No. 11/593,820, filed on Nov. 7, 2006, and entitled SYSTEM AND METHOD FOR AUTOMATED MANAGEMENT AND TRAINING IN CUSTOM HOME DESIGN AND BUILD PROJECTS, the entire contents of both which are incorporated in their entirety herein by reference. The present invention preferably includes features described therein to help organize projects in disaster areas for funding agents, such as insurance companies, banks and goverrnent agencies. Rather than attempt a high level estimate of damage, the present invention functions with users at the ground (i.e., site) level.

As used herein, the term “web site” refers to a related set of files which are maintained in one or more computer systems, referred to as “web servers” and which, when transmitted to a user terminal, cause a user terminal to display and/or execute programmatic operations corresponding to the data contained in the files. Typically, the files comprising the web site are prepared using one or more of a combination of Hyptertext Mark-Up Language (HTML), Extendable Mark-Up Language (XML), Java Applets, ActiveX programs, Standard Generalized Mark-Up Language (SGML) files and the like. Web site files are typically transmitted to a user terminal using one or more protocols, such as the Hyptertext Transfer Protocol (HTTP) under the Transmission Control Protocol/Internet Protocol (TCP/IP) suite of communication protocols.

Also as used herein, the term “browser” refers to an application program residing and executing on a user terminal which functions as an HTTP client, sending requests to web servers for web site files. A request is typically sent in the form of a Uniform Resource Locator (URL) or by selecting a hypertext link presented on the user terminal display. The browser functions to format the file and/or data received from the web server and format the received files and/or data in the manner described therein, displaying the same on the user terminal. Examples of browser programs include MICROSOFT INTERNET EXPLORER and NETSCAPE NAVIGATOR.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball and the like. Of course, one of ordinary skill in the art will appreciate that any method by which an object presented on the screen can be selected is sufficient.

Also as used herein, the term, “construction project” refers, generally, to any building activity. For example, a construction project may include construction of a new custom house or other structure. Alternatively, a construction project may refer to a renovation of an existing, such as, for example, an addition made to a house. Thus, a construction project is not intended to be limited to new buildings or modification to existing buildings.

As used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

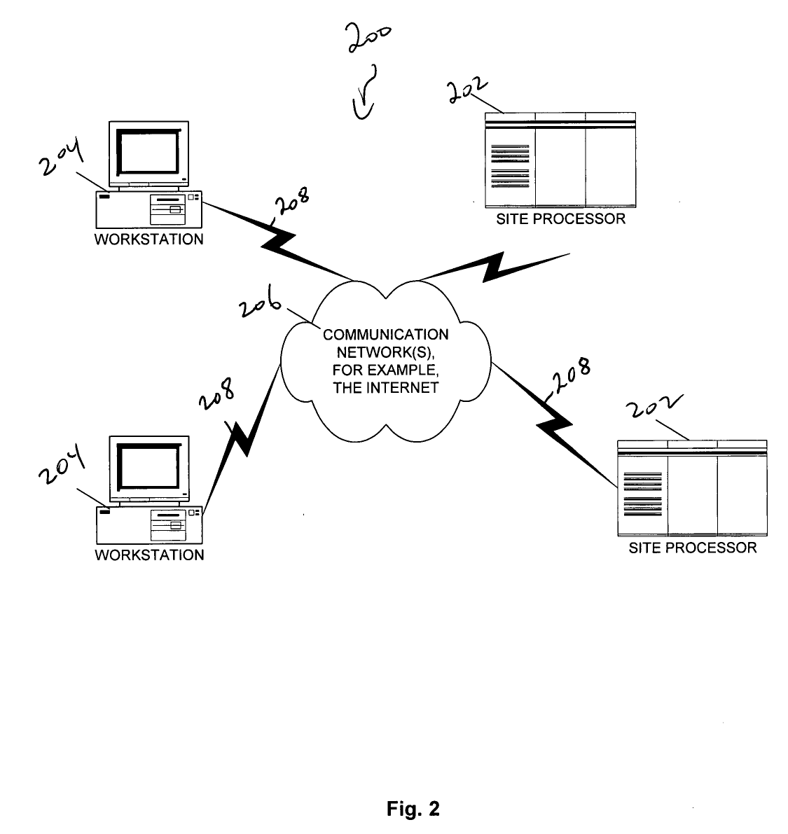

Referring now to the drawings figures in which like reference numerals refer to like elements, there is shown in FIG. 2 a diagram of an example hardware arrangement that is operate to manage replacement building projects constructed in accordance with the present invention, and designated generally as “replacement building project management system 200.” Replacement building project management system 200 is preferably comprised of one or more site processors 202 coupled to one or more workstations 204 across communication network 206.

Site processor 202 preferably includes all necessary databases for the present invention. However, it is contemplated that site processor 202 can access any required databases via communication network 206 or any other communication network to which site processor 202 has access. Site processor 202 can communicate devices comprising databases using any known communication method, including a direct serial, parallel, USB interface, or via a local or wide area network.

Workstations 204 communicate with site processors 202 using data connections 208, which are respectively coupled to communication network 206. Communication network 206 can be any communication network, but is typically the Internet or some other global computer network. Data connections 208 can be any known arrangement for accessing communication network 206, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

Workstations 204 preferably have the ability to send and receive data across communication network 206, and are equipped with web browsers to display the received data on display devices incorporated therewith. By way of example, workstation 204 may be personal computers such as Intel Pentium-class computers or Apple Macintosh computers, but are not limited to such computers. Other terminals which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 206. Of course, one skilled in the art will recognize that wireless devices can communicate with site processors 202 using wireless data communication connections (e.g., WIFI).

In addition to computer-related methods to access the system, parties who are not able to access the replacement building project management system 200 via a computer or related device can write physical letters, make telephone calls or facsimiles to parties operating in accordance with the present invention. For example, after a letter and/or telephone call is received, data-entry personnel make the necessary entries into replacement building project management system 200.

According to the present invention, workstation 204 provides user access to site processor 202 for the purpose of receiving and providing custom home replacement building-related information. The specific functionality provided by replacement building project management system 200, and in particular site processors 202, is described in detail below.

Replacement building project management system 200 preferably includes software that controls replacement homebuilding management functions and preferably resides on one or more site processors 202. One of the functions performed by site processor 202 is that of operating as a web server and/or a web site host. Site processors 202 typically communicate with communication network 206 across a permanent i.e., unswitched data connection 208. Permanent connectivity ensures that access to site processors 202 is always available.

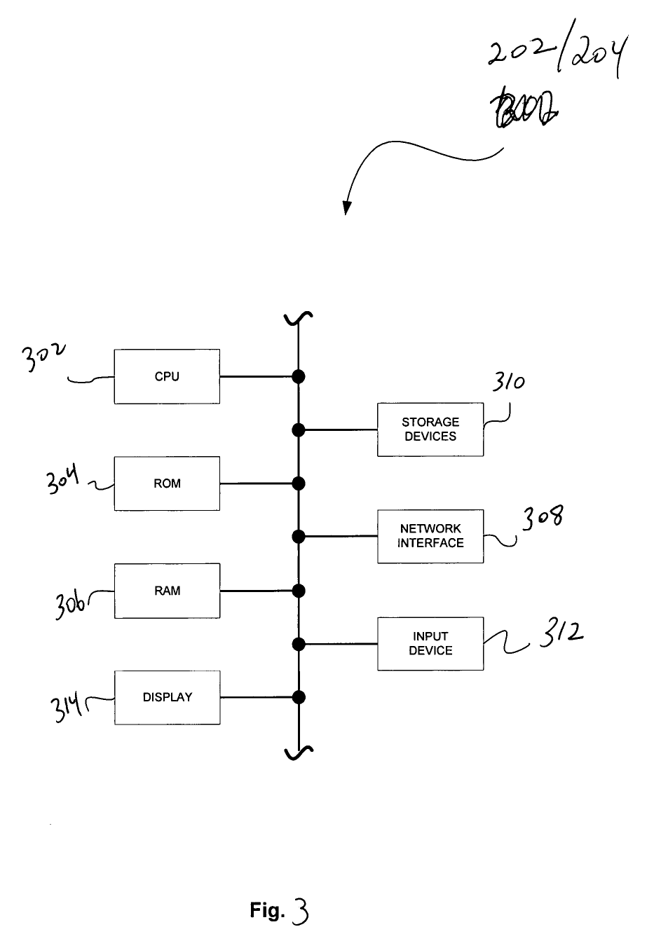

As shown in FIG. 3 the functional elements of each site processor 202 preferably include one or more central processing units (CPU) 302 used to execute software code in order to control the operation of site processor 202, read only memory (ROM) 304, random access memory (RAM) 306, one or more network interfaces 308 to transmit and receive data to and from other computing devices across a communication network, storage devices 310 such as a hard disk drive, floppy disk drive, tape drive, CD-ROM or DVD drive for storing program code, databases and application code, one or more input devices 312 such as a keyboard, mouse, track ball and the like, and a display 314.

The various components of site processor 202 need not be physically contained within the same chassis or even located in a single location. For example, as explained above with respect to databases which can reside on storage device 310, storage device 310 may be located at a site which is remote from the remaining elements of site processors 202, and may even be connected to CPU 302 across communication network 206 via network interface 308.

The functional elements shown in FIG. 3 (designated by reference numbers 302-314) are preferably the same categories of functional elements preferably present in workstation 204. However, not all elements need be present, for example, storage devices in the case of PDAs, and the capacities of the various elements are arranged to accommodate expected user demand. For example, CPU 302 in workstation 204 may be of a smaller capacity than CPU 302 as present in site processor 202. Similarly, it is likely that site processor 202 will include storage devices 310 of a much higher capacity than storage devices 310 present in work station 204. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, and web application development environments.

As used herein, references to displaying data on workstation 104 refer to the process of communicating data to the terminal across communication network 206 and processing the data such that the data can be viewed on the workstation 104 display 314 using a web browser or the like. The display screens on workstation 104 present areas within replacement building project management system 200 such that a user can proceed from area to area within the replacement building project management system 200 by selecting a desired link. Therefore, each user's experience with replacement building project management system 200 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of replacement building project management system 200.

Although the present invention is described by way of example herein in terms of a web-based system using web browsers and a web site server (site processor 202), replacement building project management system 200 is not limited to that particular configuration. It is contemplated that replacement building project management system 200 can be arranged such that workstation 204 can communicate with, and display data received from, site processor 202 using any known communication and display method, for example, using a non-Internet browser Windows viewer coupled with a local area network protocol such as the Intemetwork Packet Exchange (IPX). It is further contemplated that any suitable operating system can be used on workstation 204, for example, WINDOWS 3.X, WINDOWS 95, WINDOWS 98, WINDOWS 2000, WINDOWS CE, WINDOWS NT, WINDOWS XP, WINDOWS VISTA, LINUX and any suitable PDA or palm computer operating system.

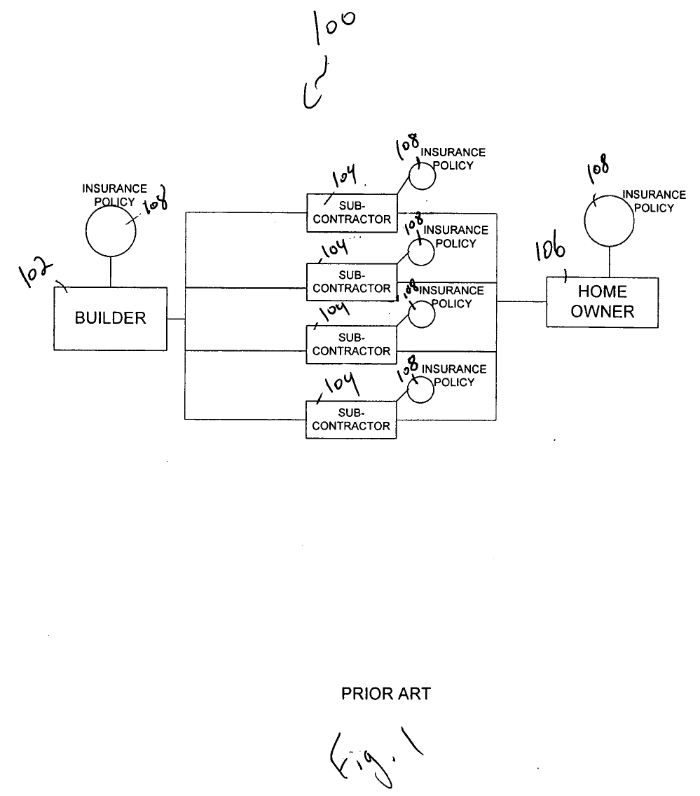

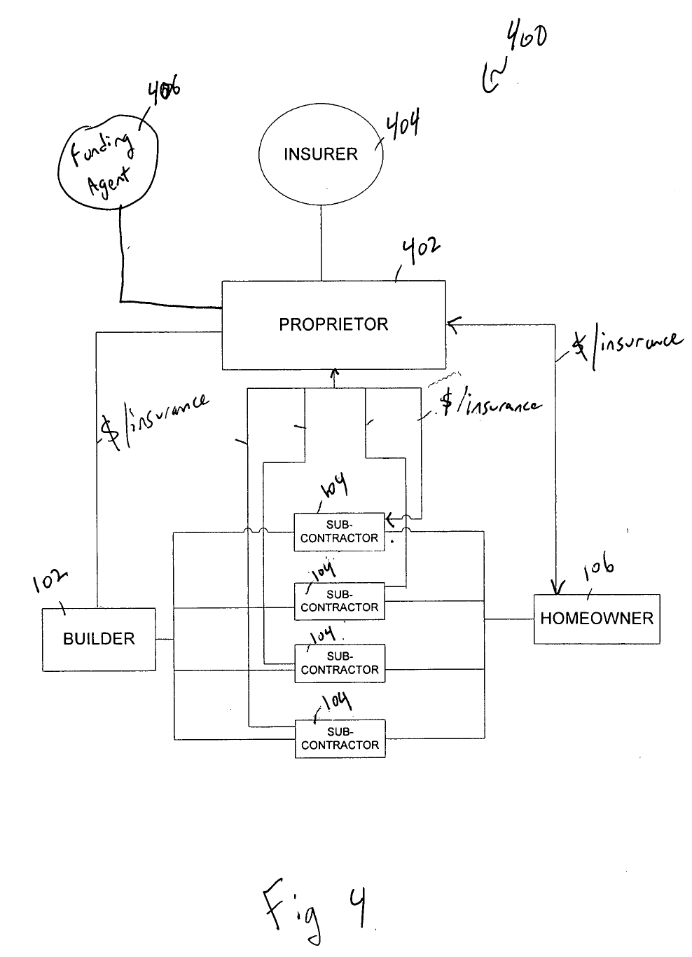

FIG. 4 shows a block diagram arrangement 400 of parties in accordance with a preferred embodiment of the present invention. Similar to the known arrangement shown in FIG. 1, FIG. 4 includes a builder 102 working with a plurality of subcontractors 104 to construct and sell a home that is a rebuild or replacement home damaged, for example, in a disaster relief area to a homeowner 106. Included in arrangement 400, and not shown in FIG. 1, are proprietor 402, insurer 404 and funding agent 406. Proprietor 402 is preferably one or more parties who provide the present invention, including to control the many features set forth herein, in order to enable the parties illustrated in FIG. 4 to build replacement home projects in accordance with the teachings herein. In one context, proprietor 402 may control site processor 202 in order to provide the data entry display screens and corresponding graphical screen controls, as shown and described herein.

Yet another aspect of the present invention relates to an improved system and method for providing insurance coverage to builders, subcontractors and homeowners.

In accordance with a preferred embodiment, proprietor 402 utilizes the various features of the present invention, including the various software modules and controls, to enable parties to electronically submit parameters into, for example, an internet software application regarding a replacement building project. The replacement building project parameters include, for example, contact (e.g., homeowner 106) information, pre-disaster discovery data, replacement home building options, re-build plans and contractual information. The application accurately predicts labor and materials costs associated therewith. The present invention also preferably provides details directed to the processes associated with custom homebuilding projects and eliminates surprises that may arise during a building process. Such features are described in greater detail in co-pending and commonly assigned U.S. patent applications, Ser. Nos. 11/029,569 and 11/593,820.

In accordance with a business method associated with a preferred embodiment of the present invention, a contractual or other binding agreement is preferably entered into between the proprietor and the insurer in which the insurer provides insurance coverage proprietor# associated with the replacement homebuilding project. Proprietor 402, in turn, provides insurance coverage to builder 102, subcontractors 104 and homeowner 106 in accordance with one or more respective replacement homebuilding projects. Builder 102, subcontractor 104 and homeowner 106 are each preferably charged a fee by proprietor 402 for services related to managing a custom build project. Preferably, part of the fee charged to the parties includes the cost associated with insurance. In this way, a single insurance arrangement can be provided by insurer 404 to proprietor 402, and overhead costs associated with individual insurance policies purchased from a plurality of insurance providers are eliminated. FIG. 4 illustrates the transfer of money and insurance between proprietor 402 and the parties 102, 104 and 106.

Thus, in accordance with a preferred embodiment and illustrated in FIG. 4, the present invention provides an arrangement 400 between parties that is an improvement over known home rebuilding projects. Since the costs associated with purchasing insurance in the prior art are typically high, builders 102, subcontractors 104 and homeowners 106 realize tremendous savings using the present invention because insurance policies are provided for them and factored into the cost of working with proprietor 402. Further, insurer 404 realizes increased profit because the single insurer provides insurance for many more parties (potentially thousands of builders 102, subcontractors 104 and homeowners 106) than in the prior art.

In a preferred form, a software application is provided, preferably over the internet, and used to gather and collect historical data of a prior damaged or destroyed home and to estimate quickly reliable replacement costs. Preferably, this is accomplished by working with homeowners 102, insurance agents and local building inspectors, as necessary, to adjust for example, for zoning and other legal code changes. Further, managed services and progress of a rebuilding project is viewed on the project's web site and summarized in local and regional reports.

In a preferred embodiment, various display screens are provided to users operating site processor 202 or workstation 204. For example, a management view, an agent view and an individual claim view (e.g., directed to a homeowner) are preferably provided for managers, agents (e.g., funding or insurance agents) and homeowners. The views enable users to add, edit and/or view data associated with a respective replacement project in a disaster relief area. Accessing a management view section, for example, allows, users, such as managers, to select an agent name and view respective claims that the selected agent is handling or was otherwise involved in. Selecting a respective claim preferably enables the user (e.g., manager) to submit and/or review information in a specific project data entry display screen for the respective claim.

The project page preferably defines steps and processes for working directly with the parties in order to electronically collect to define and organize large numbers of disaster projects simultaneously. The invention preferably enables one trained representative to manage a number (e.g., fifty) of disaster projects, and the invention has unlimited scalability.

Once site data are collected, building codes and associated financial cost data are reference and calculated, and homeowners and insurance agents preferably meet to make a decision on how to proceed. The parties may elect to use software and services to manage the rebuilding project from beginning to end, for example by using technology and feature's shown and described in co-pending and commonly assigned U.S. patent application, Ser. No. 11/029,569. The present invention preferably manages parties and activities associated with rebuilding costs, plans and specifications development, building supervision, national, zone and local vendors and subcontractors. Further closing, post closing and warrantee issues for all involved parties are preferably managed via the present invention.

FIG. 5 is a flow chart illustrating steps 100 associated with submitting and retrieving information related to replacement of buildings damaged or destroyed, for example, following a disaster.

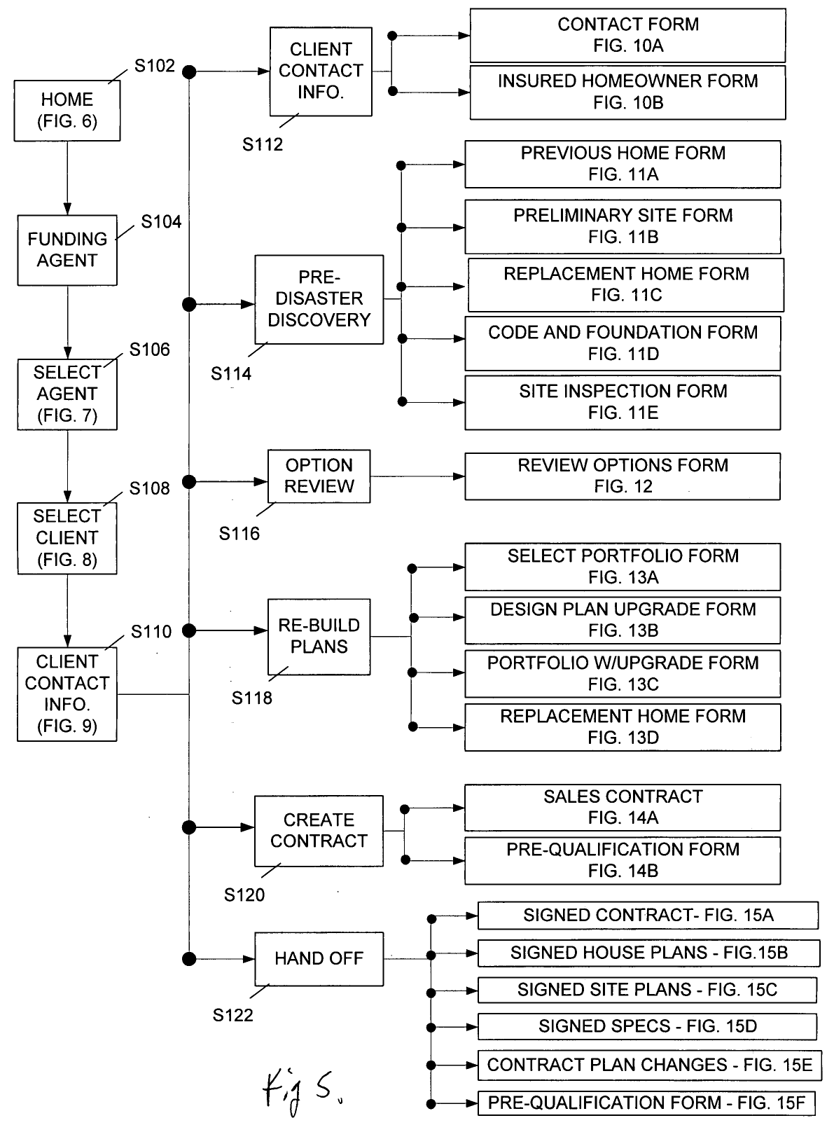

FIGS. 6-15F are associated with an embodiment of the present invention and include data entry display screens and data output reports, which parties use to submit and review information relating to replacing damaged or destroyed building structures. The data entry display screens illustrated in FIGS. 6-15F ensure efficient management of the parties, and accurate predictions of cost and time requirements associated with rebuilding a damaged or destroyed building structure.

In the examples shown in FIGS. 6-15F, a funding agent 406 is the example user of and is using the invention to review and/or submit information related to replacing a home damaged or destroyed by a disaster.

In a preferred embodiment, proprietor 402 or authorized user associated thereof uses the invention to gather information regarding a damaged or destroyed house, and submits information in various data entry forms, such as shown in FIGS. 6-15F, prior to the time when funding agent 406 reviews the data. Moreover, proprietor 402 (or authorized user) preferably works with homeowner 106 to define features and/or upgrades that homeowner 106 would like to include in the replacement home. In a preferred embodiment, proprietor 406 offers a service for funding agents, insurers, banks, government agencies or other parties associated with disaster relief by providing electronic information related to a disaster relief claim.

Referring now to the flowchart shown in FIG. 5, and in the accompanying FIGS. 6-15F, at step S102, the user operating a workstation 204 that is preferably equipped with web browsing software connects to a web server and is provided with an internet web site, substantially as shown in example display screen 600 (FIG. 6). At step S104, the user selects a hyperlink 602 (FIG. 6) that is provided for a funding agent to submit and review information in accordance with the teachings herein. After selecting hyperlink 602 (step S106), the user is presented with display screen 700, substantially as shown in FIG. 7.

Display screen 700 includes a table of hyperlinks 702 that are each directed to a respective funding agent. After the user selects icon hyperlink 704, display screen 800 is preferably provided (FIG. 8, step S108) and a selectable list 802 of clients, e.g., people whose homes have been damaged or destroyed in a disaster, is displayed. Each of the names listed in display screen 800 are preferably formatted as hyperlinks that, when selected, cause the web server to display screen 900 substantially as shown in FIG. 9 (step S110).

FIG. 9 illustrates an example display screen 900 that identifies a particular client selected in step S110 for a respective funding agent identified in step S108.

In a preferred embodiment, display screen 9 includes information representing a client name, claim number, status of claim, city, state, county and zip code. Moreover, display screen 9 includes a series of tabs 902, 904, 906, 908, 912 and 914 that, when selected, enable the user to submit information in various contexts. For example, Contact Info tab 902 (step S112), when selected, enables a user to submit and/or review client contact information. Pre-disaster Discovery tab 904 (step S114), when selected, enables a user to submit and/or review pre-disaster discovery information. Option Review tab 906 (step S116), when selected, enables a user to review various options and associated costs with regard to a re-build/renovator repair process. Re-build Plans tab 908 (step S118) enables a user to submit and/or review information directed to various features of a replaced/renovated building structure in accordance with the present invention. Create Contract tab 910 (step S120) enables the user to submit and/or review sales contract and pre-qualification contract information. Hand Off tab 912 (step S122) enables the user to hand off to a builder or other managing party the contract, house plans, site plans, specification, changes and pre-qualification (for financing). Thus, using the tabs and display screens, such as outlined in FIG. 5, a funding agent can gather, review and transmit information to expedite a process of re-building or replacing a building structure damaged in the wake of a disaster.

FIGS. 10A and 10B show display screens 1000A and 1000B that are provided when a user selects Contact Info tab 902. As shown in FIG. 10A, contact information for a client is displayed after the user selects contact report side tab 1002. The kind of information displayed in display screen 1000A includes demographic information for a client, origin of contact, likelihood of potential outcome and any comments the funding agent may wish to provide. Display screen 1000B is displayed when the user preferably selects insured owner report tab 1004. Owner report tab 1004, when selected, enables the user to identify whether the contact is interested in re-building, whether the project is a renovation or rebuild, the approximate time-frame for re-building, the status of house plans, type of foundation, value of the lot, insurance agent, whether a claim is pending, funds have been dispersed or any other comments that the user may wish to submit.

FIGS. 11A-11E show example display screens 1100A-1100F that identify data entry forms that are presented to a user to submit information representing a client's previous home. A user selects, for example, Previous Home side tab 1102 to submit and/or review features, square footage and allowance information for the client's previous (e.g., damaged or destroyed) home. Display screen 1100B is provided after the user selects Preliminary Site Data side tab 1104. In display screen 1100B, the user submits/reviews information representing a building site (i.e., flat, elevated, sloping, etc.), as well as additional costs that may be associated with the project.

FIG. 11C illustrates example display screen 1100C that is provided in response to a user selecting Replacement Home side tab 1106. The graphical screen controls provided in display screen 1100c are similar to those provided in FIG. 11A, and are provided to enable a user to submit/review options associated with the replacement home.

FIG. 11D illustrates example display screen 1100D and is preferably provided in response to a user selecting Code and Foundation side tab 1108. Display screen 1100D is operable for the user to submit/review information representing upgrades to the site of a user's damaged or destroyed home. The graphical screen controls are similar to those illustrated in FIG. 11B.

FIG. 11E illustrates example display screen 1100E and is provided in response to a user selecting Site Inspection side tab 1110. Preferably, an official site inspection is performed by visiting a site and submitting information in display screen 1100E. For example, a user submits information describing the site, planning and zone restrictions, unusual costs or other information.

FIG. 12 shows an example display screen 1200 and provided in response to a user selecting option review tab 906. Display screen 1200 enables a user to submit and/or review information regarding rebuilding costs, outstanding obligations, insurance and other cash proceeds, and funding options to assess total funds for an project.

FIGS. 13A-13D illustrate example display screens 1300A-1300D, respectively, for submitting/reviewing information regarding rebuilding a building structure, and are provided in response to a user selecting Re-Build Plans tab 908 and Select Portfolio Model side tab 1302 (FIG. 13A), Design Plan Upgrades side tab 1304 (FIG. 13B), Portfolio with Upgrades side tab 1306 (FIG. 13C) or Replacement Home side tab 1308 (FIG. 13D).

Display screen 1300A, illustrated in FIG. 13A, includes graphical screen controls defining features, square footage and allowances for a replacement building. Portfolios relate to a plurality of residential building styles within, for example, a specific price range.

Display screen 1300B, illustrated in FIG. 13B, is provided for users to submit and review information related to plan upgrades.

Display screen 1300C, illustrated in FIG. 13C, provides controls for a user to submit/review plan upgrades to a portfolio model. The graphical screen controls represent features, square footage and allowances for the plan upgrades.

FIG. 13D illustrates display screen 1300D, which includes similar graphical screen controls included in display screen 1300C, but are provided for entering/reviewing data regarding a replacement home.

Thus, FIGS. 13A-D, respectively, enable a user to select a portfolio model, design plan upgrades, select a portfolio with upgrades and submit replacement home data.

FIGS. 14A and 14B illustrate example display screens 1400A and 1400B, respectively, and are provided in response to a user selecting Create Contract tab 910. Display screen 1400A illustrates an example sales contract that is preferably automatically generated in response to entries made in accordance with the teachings herein, and in response to the user selecting Sales Contract side tab 1402. Display screen 1400B illustrates an example mortgage pre-qualification form, as frequently used to establish whether a potential client can be pre-qualified to borrow capital, and provided in response to a user selecting Pre-Qualification Form side tab 1404.

Once data directed to the above-described elements have been submitted and relevant agreements have been executed, the user preferably “hands off” the project to enable construction to begin. The project may be handed off to a building contractor who is otherwise unaffiliated with a proprietor of the present invention and/or the invention described in co-pending U.S. patent application, Ser. No. 11/029,569, or the project may be handed off to an affiliated builder. In any case, the present invention stores various legal documents in digital form that authorize parties to commence replacing buildings damaged or destroyed in the wake of a disaster.

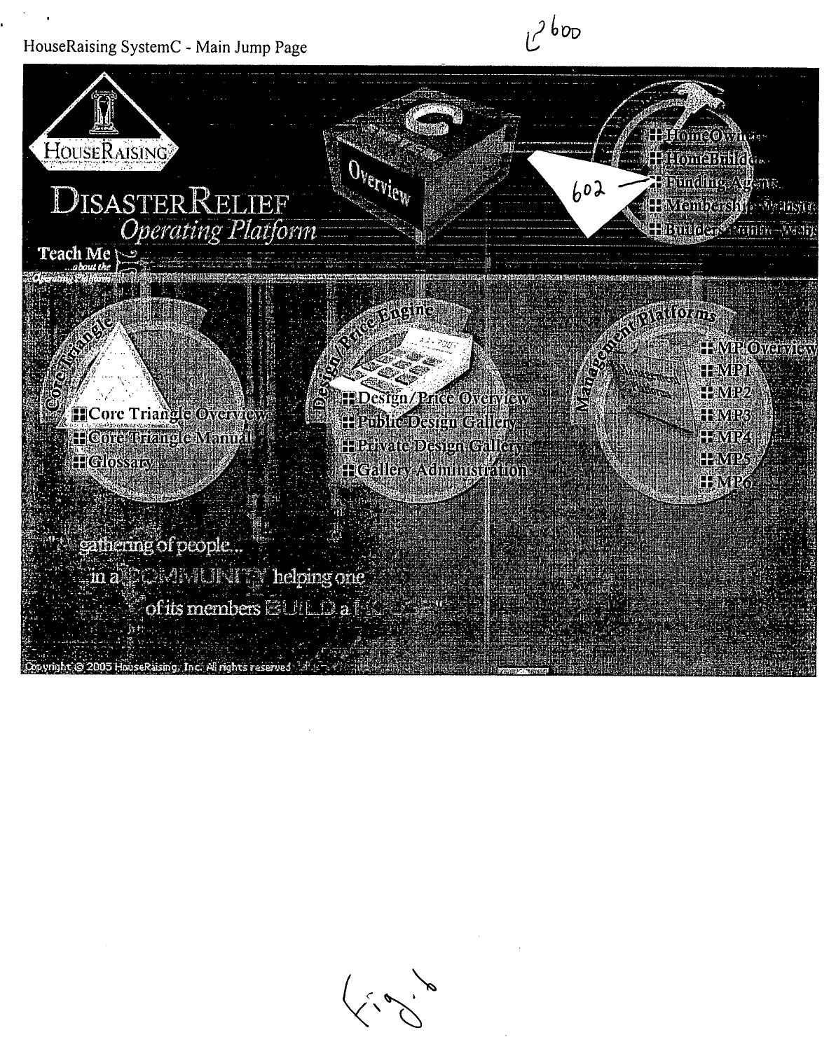

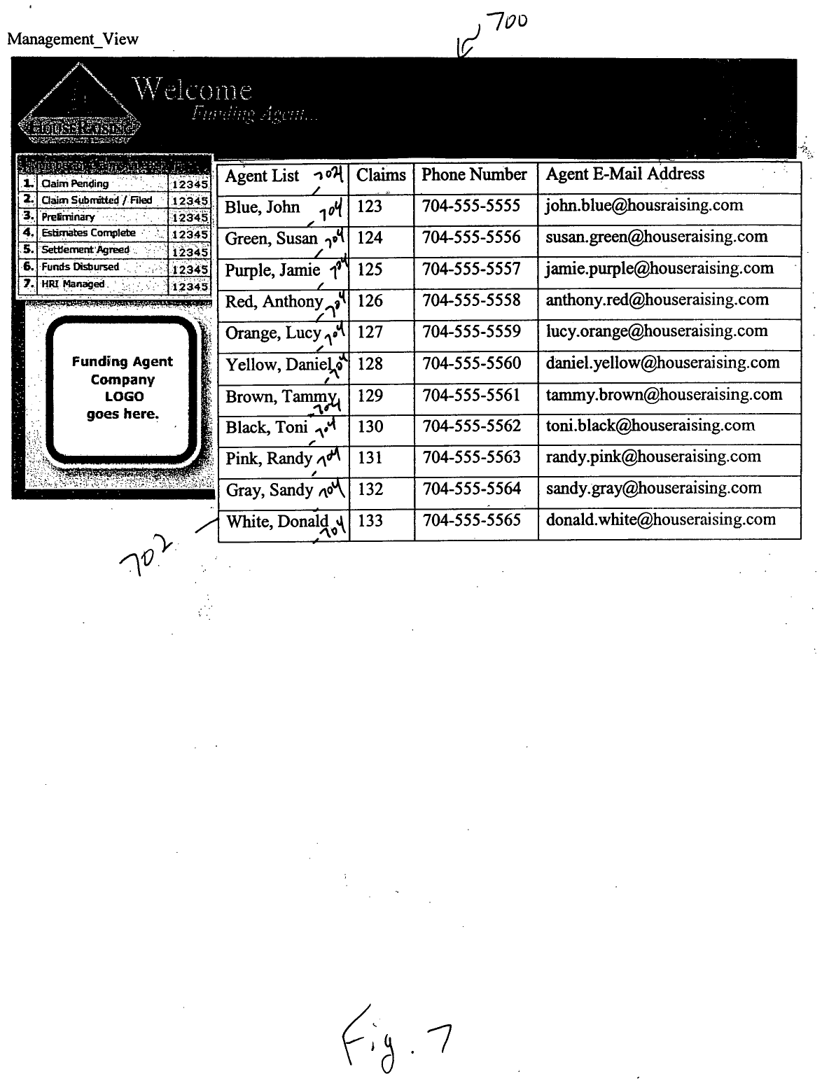

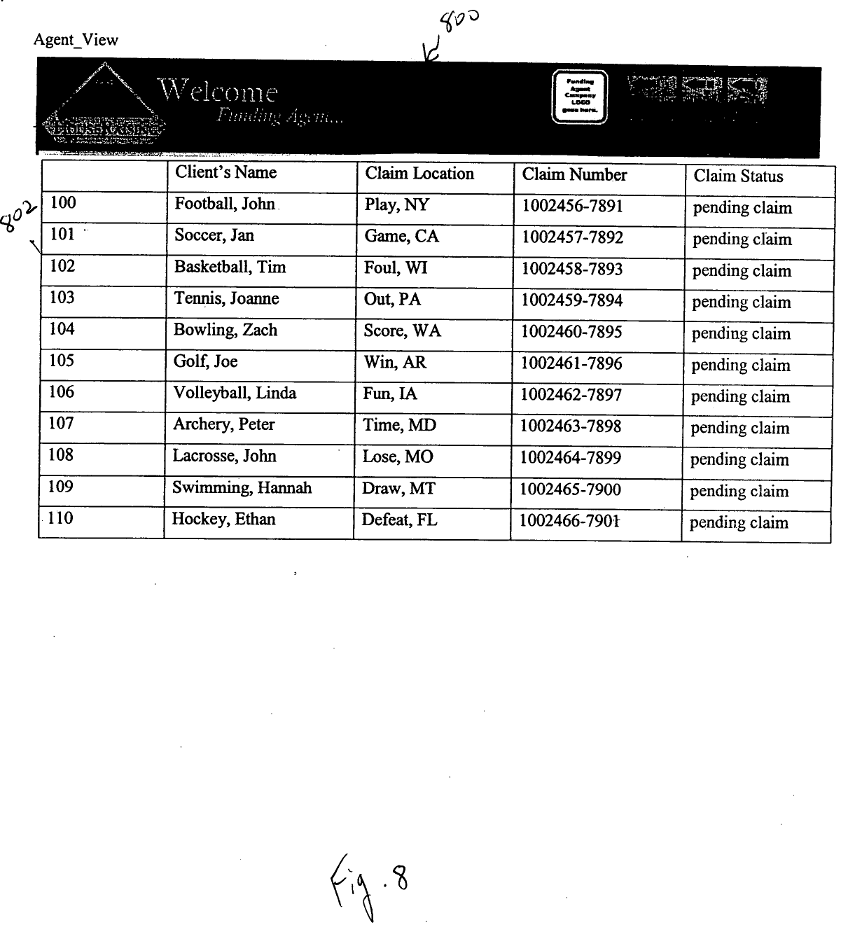

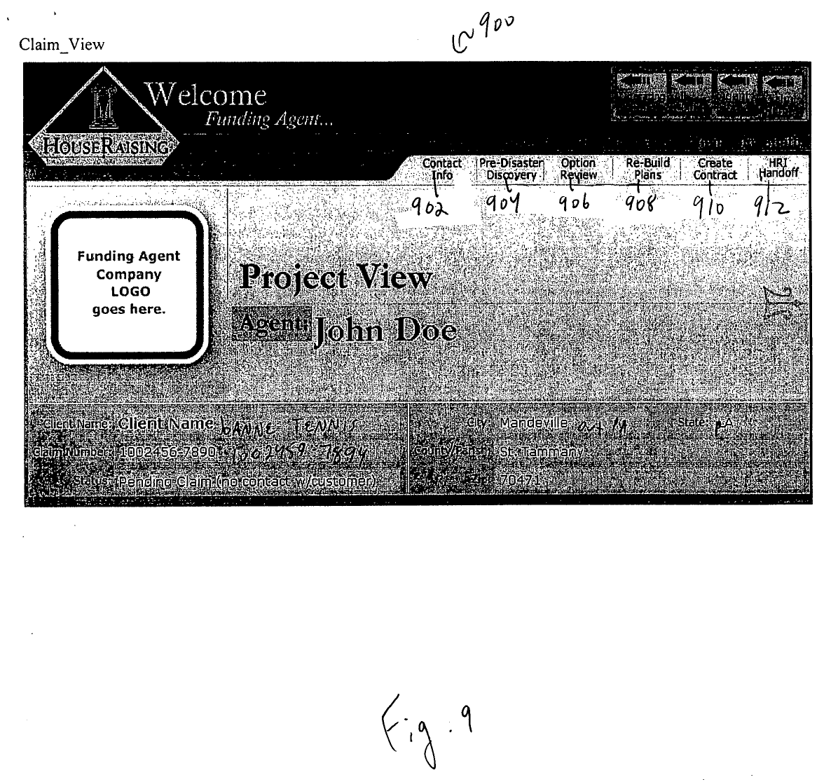

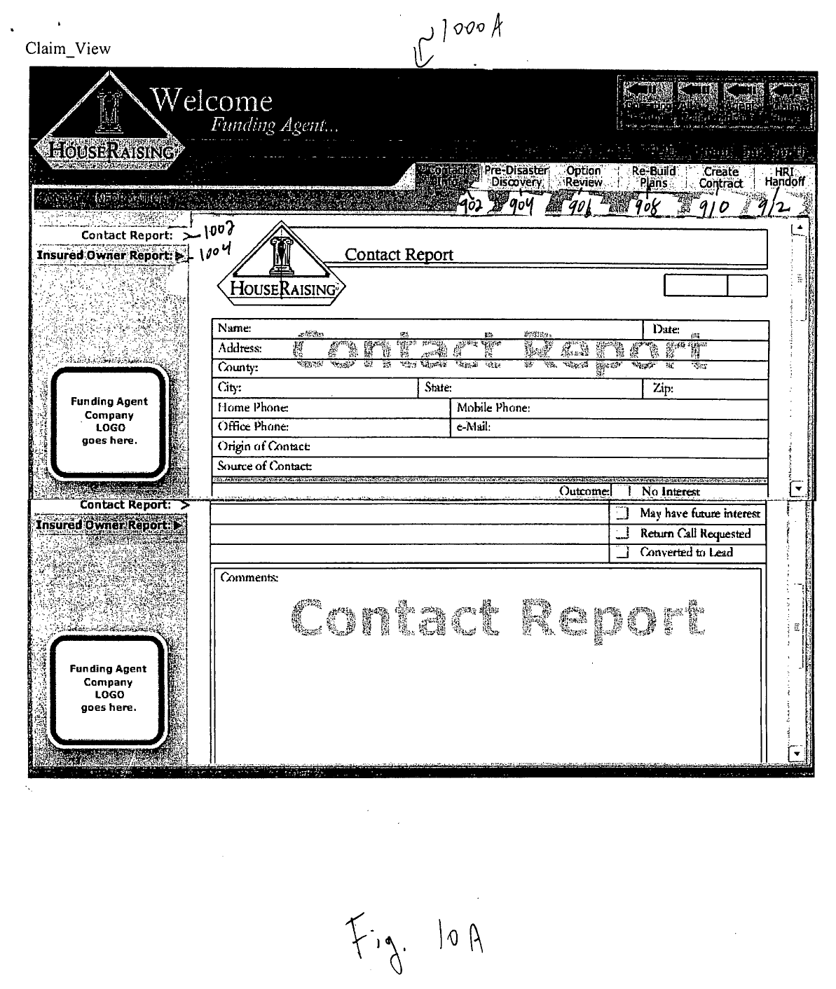

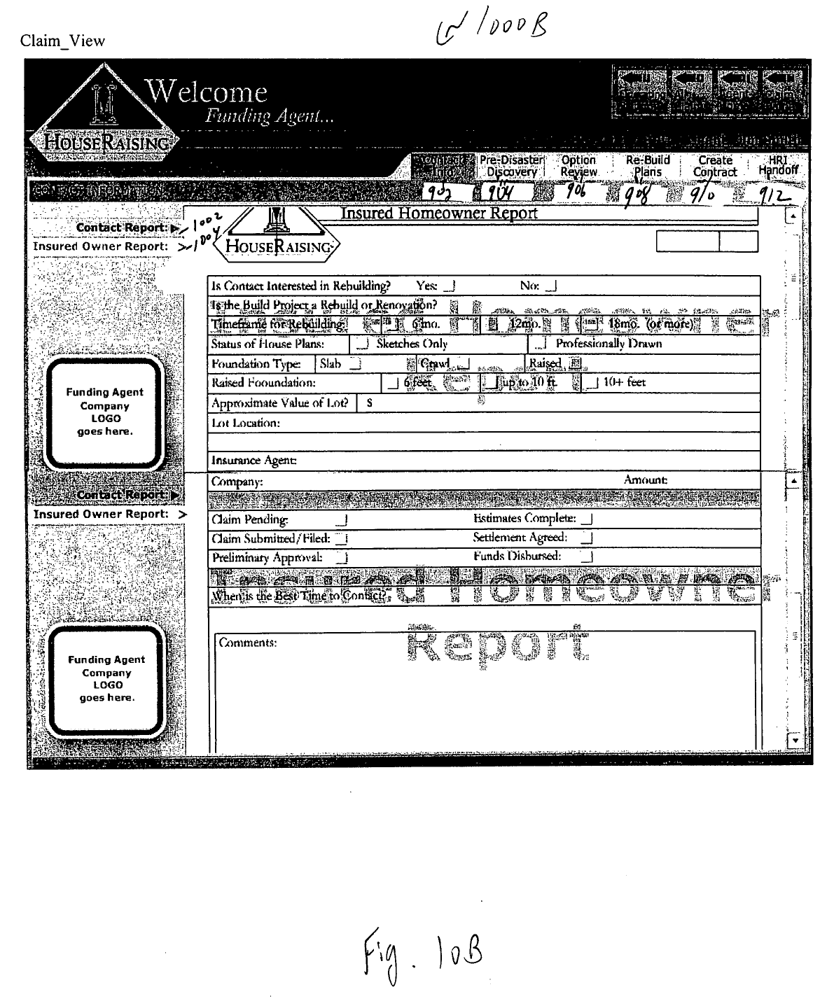

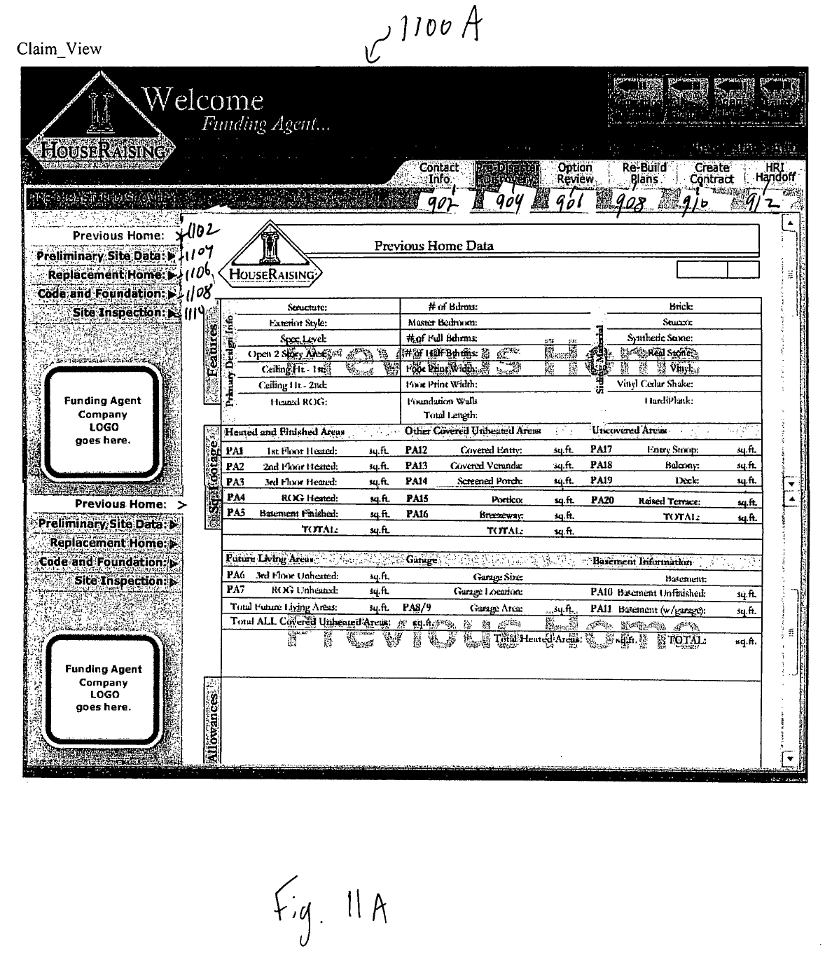

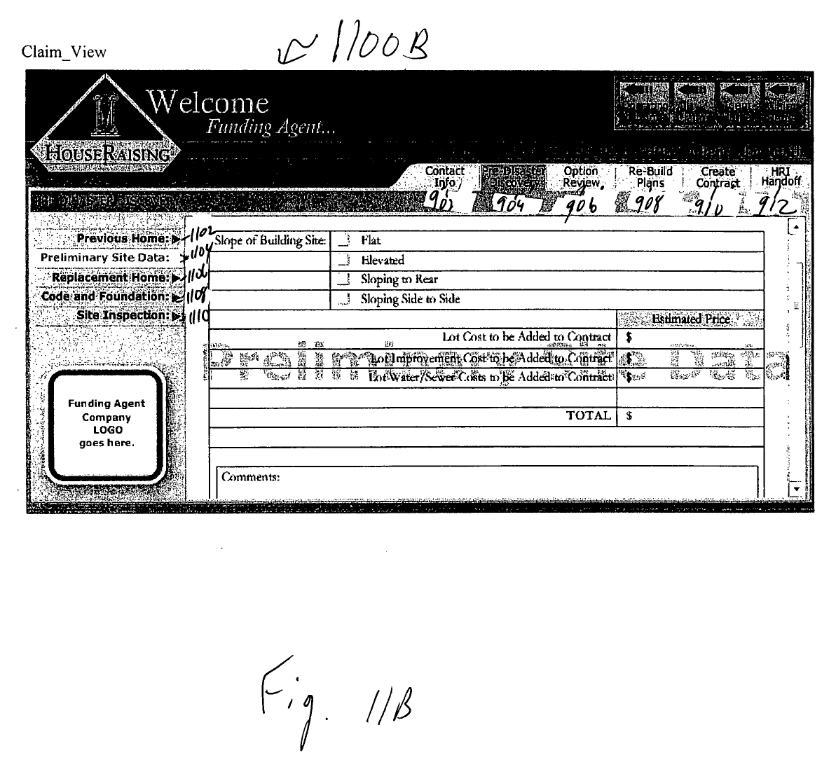

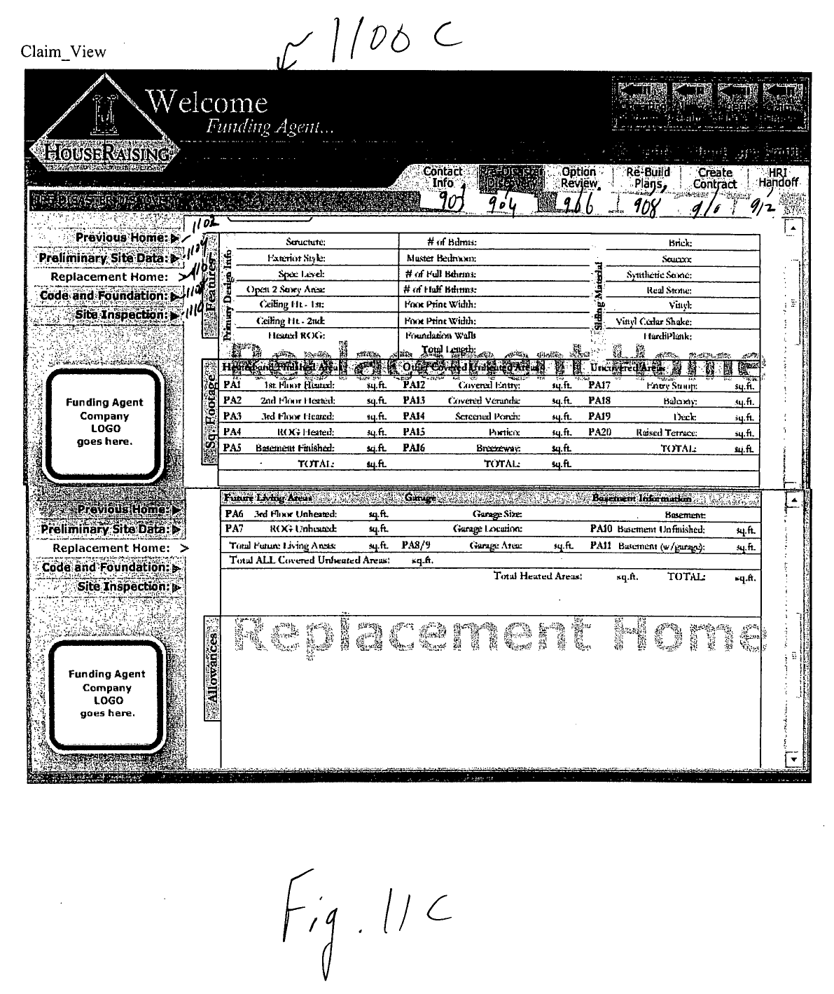

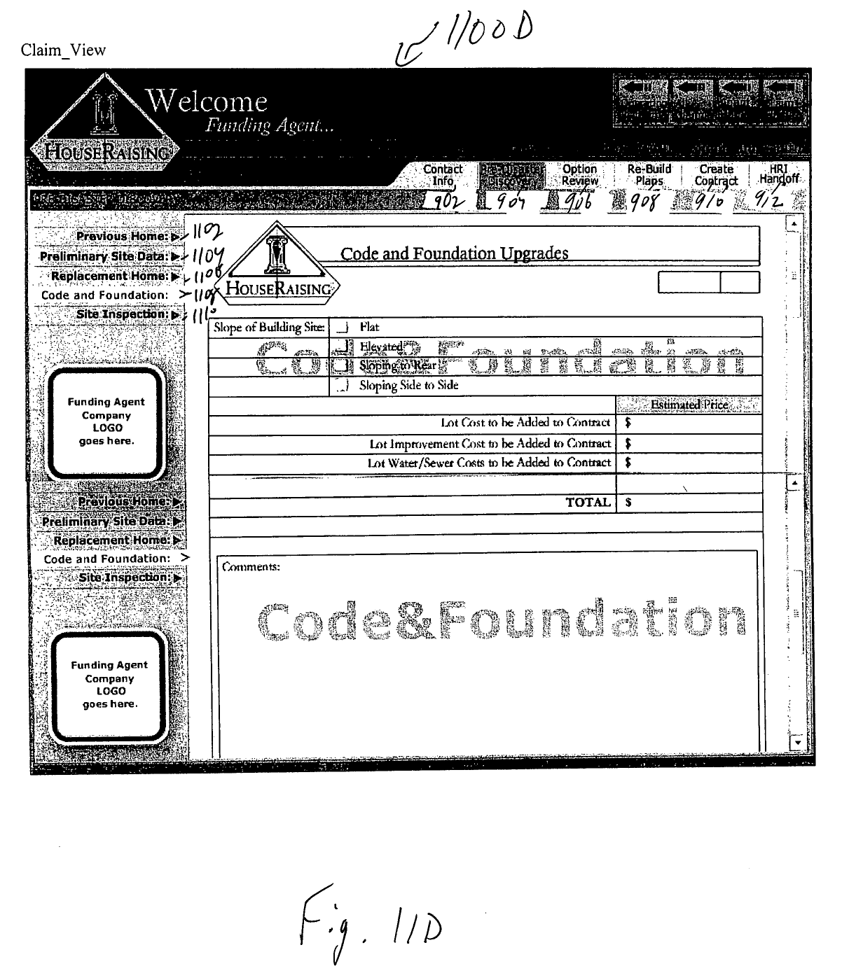

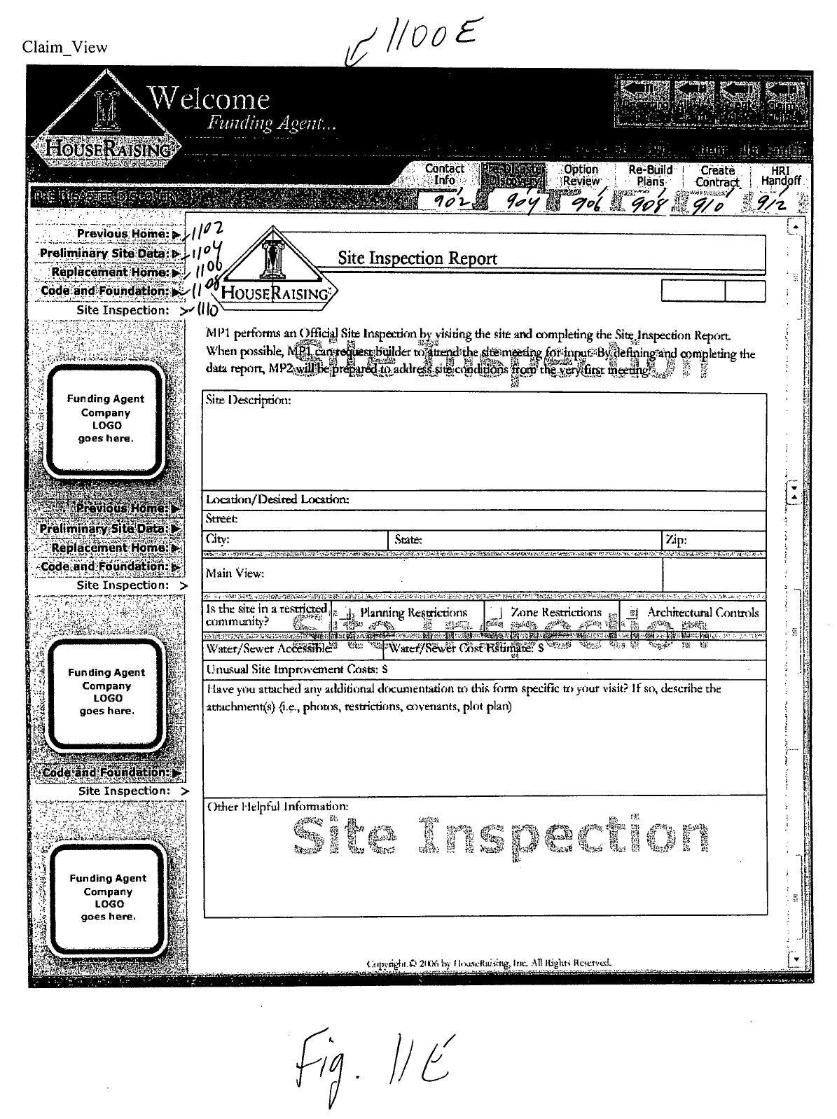

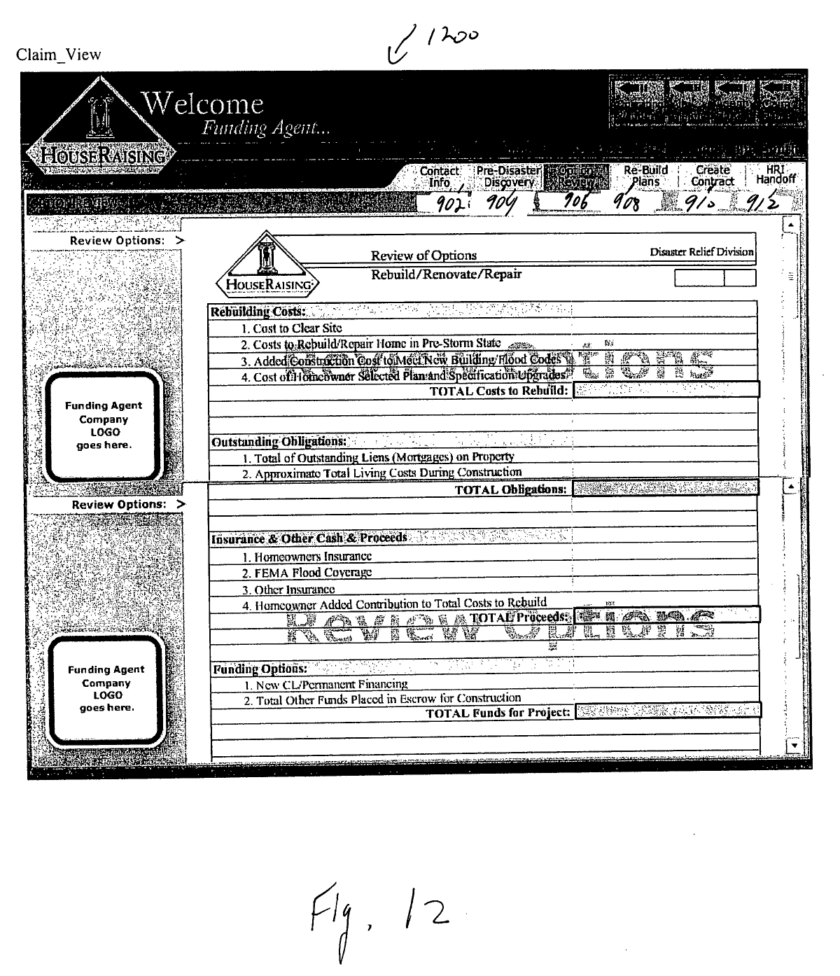

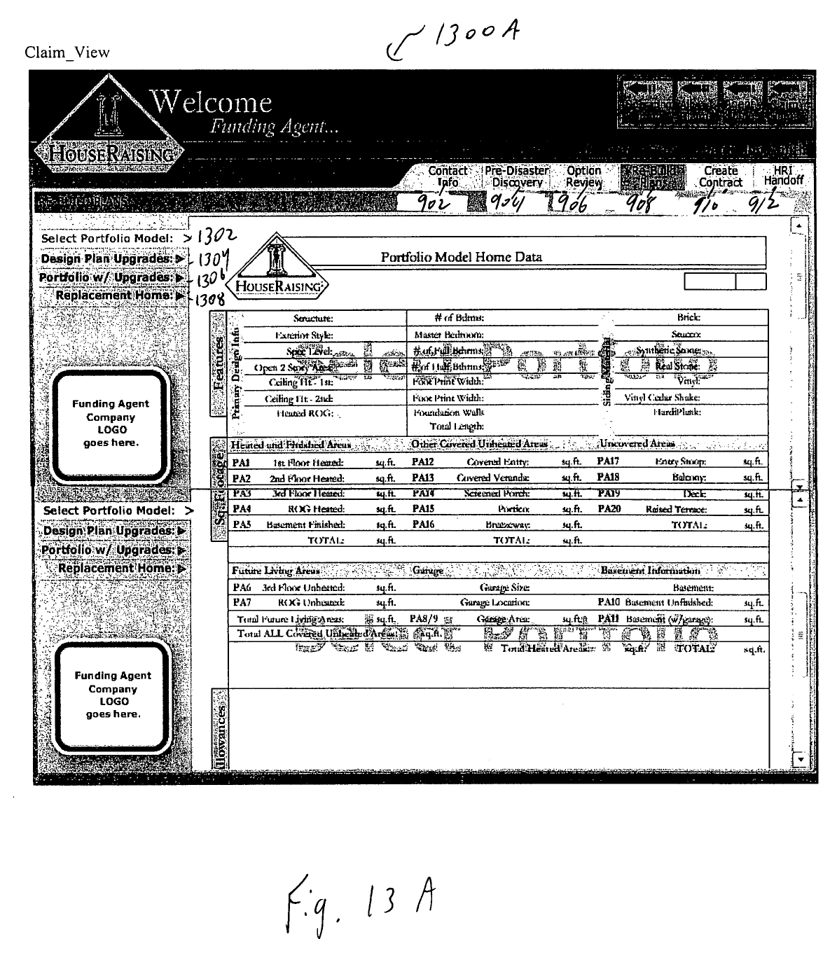

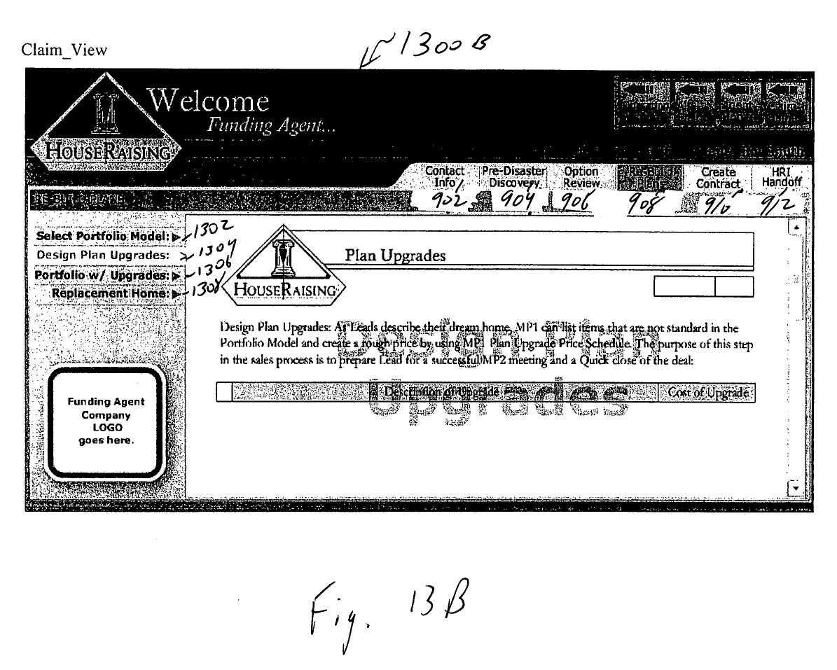

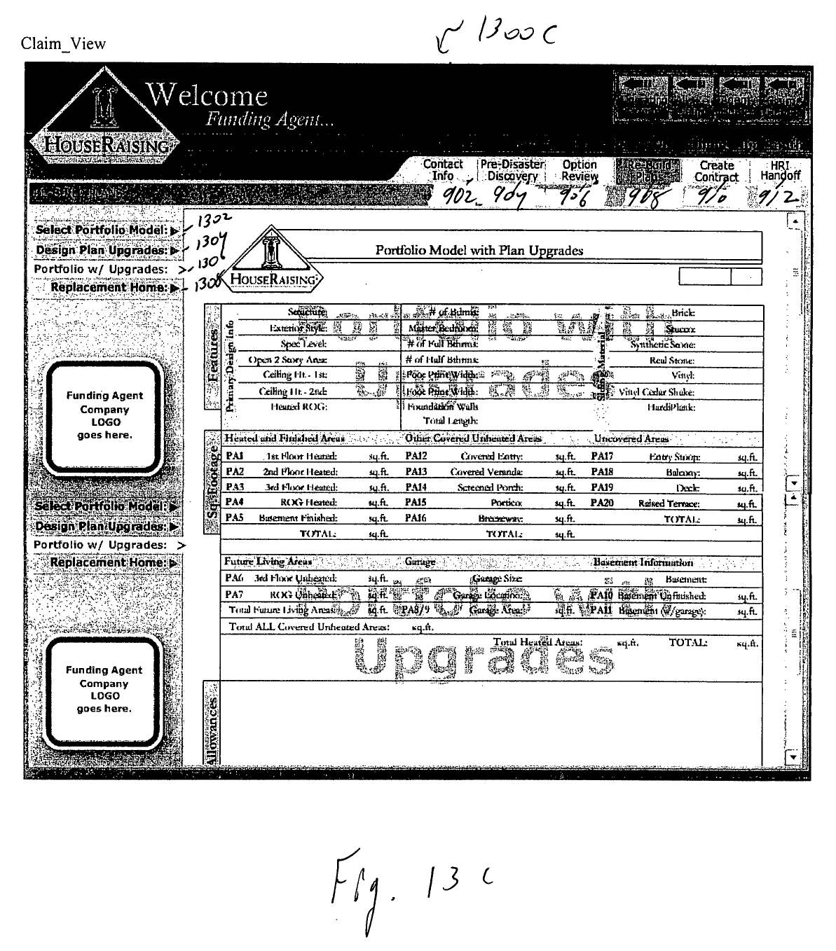

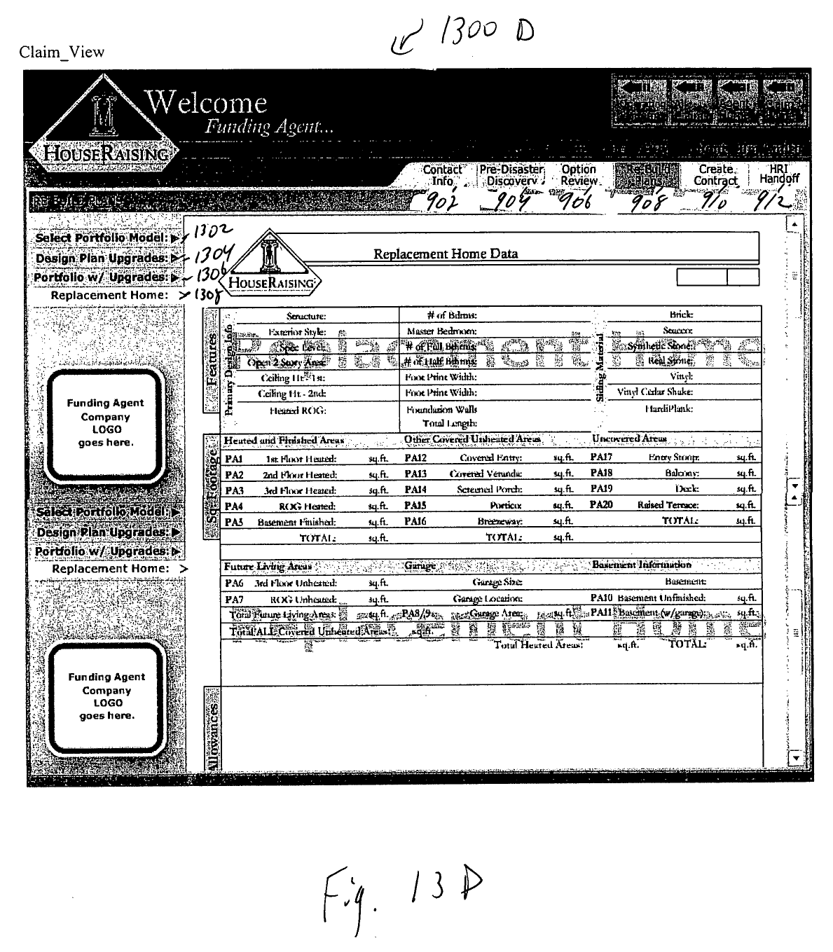

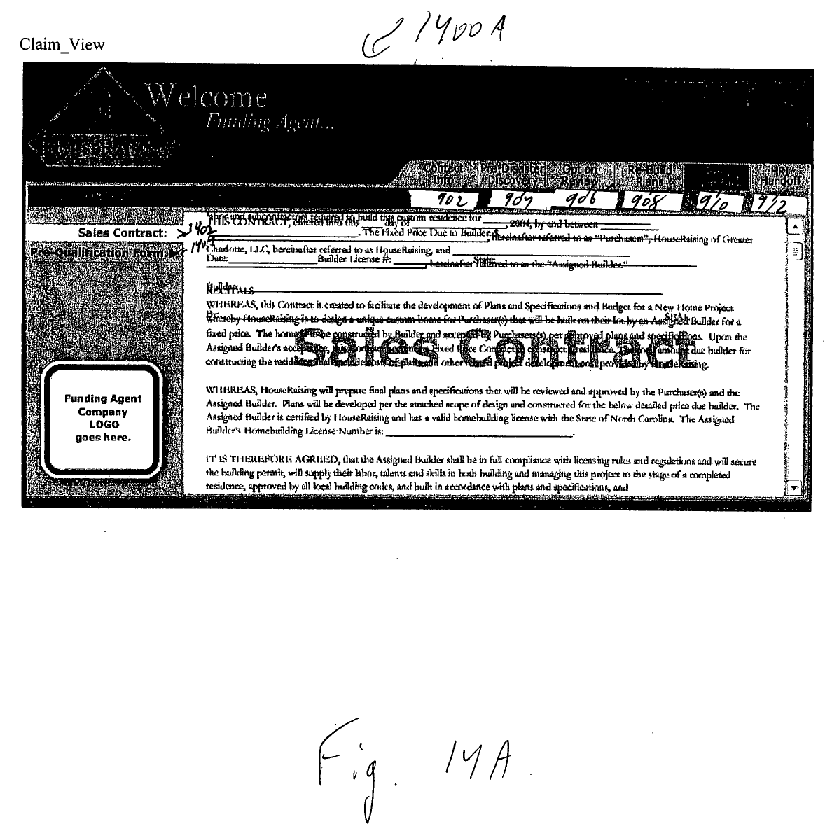

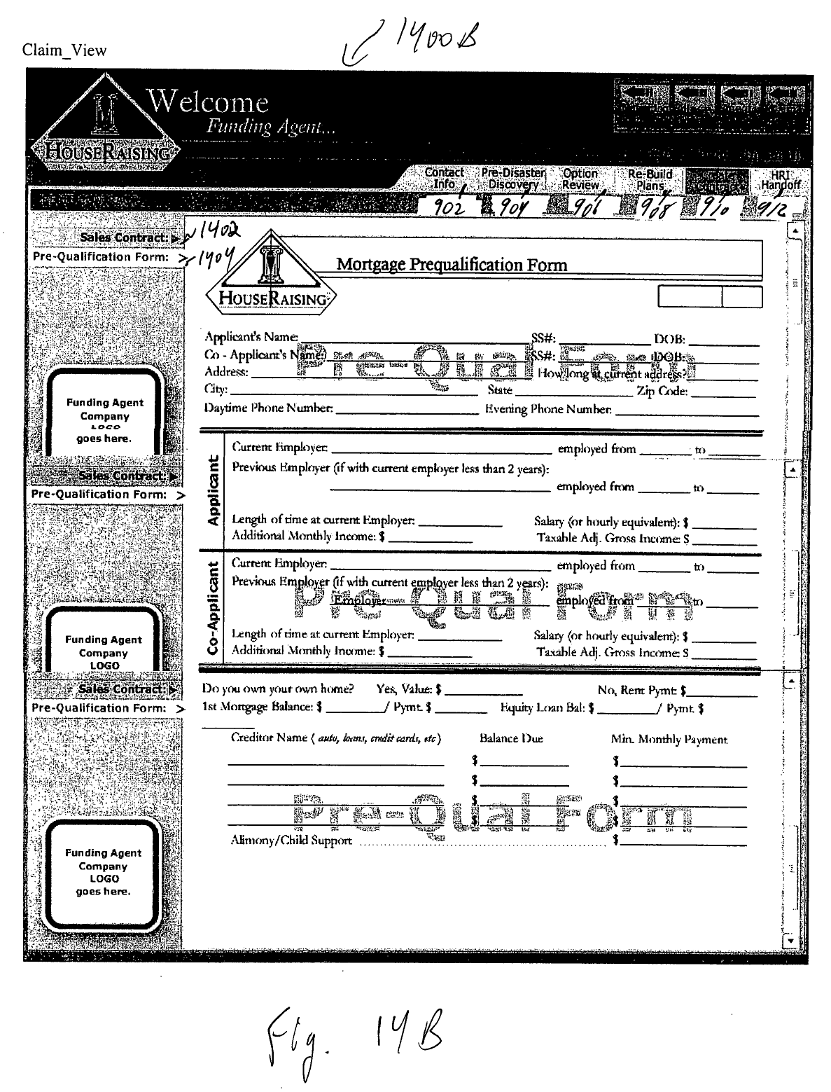

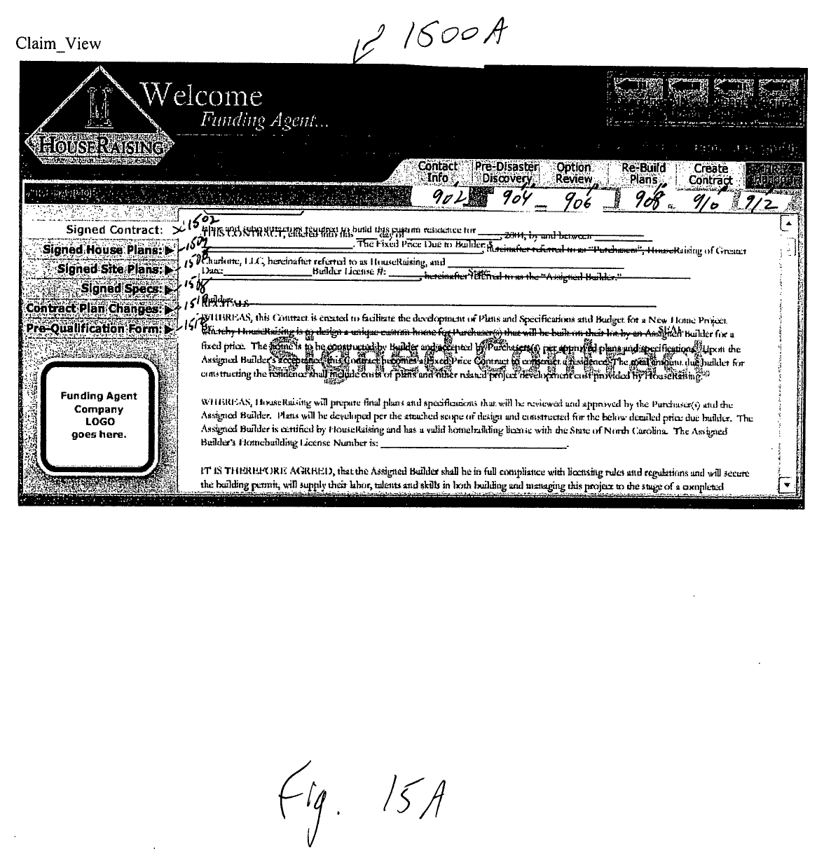

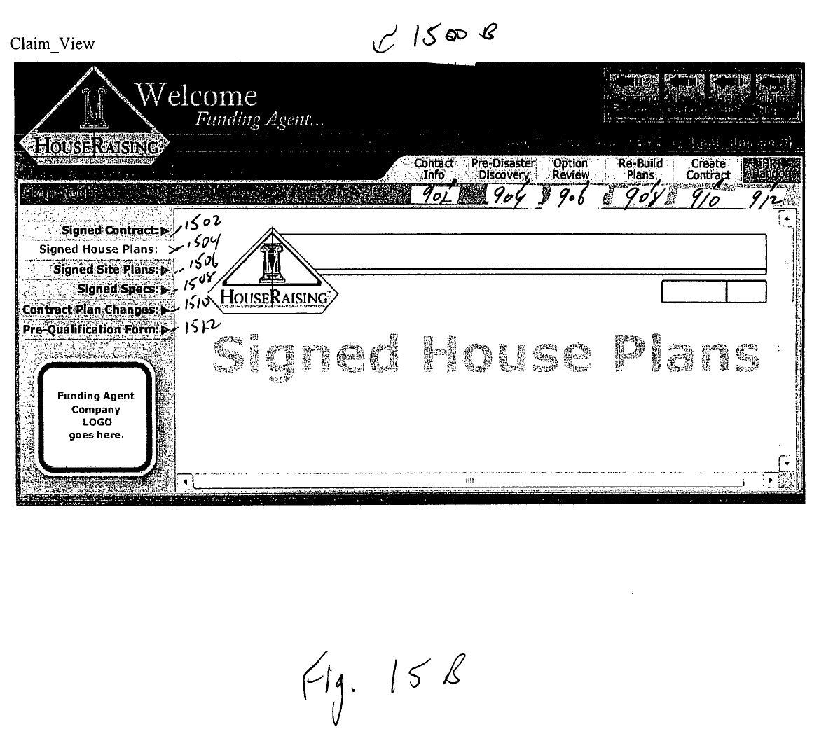

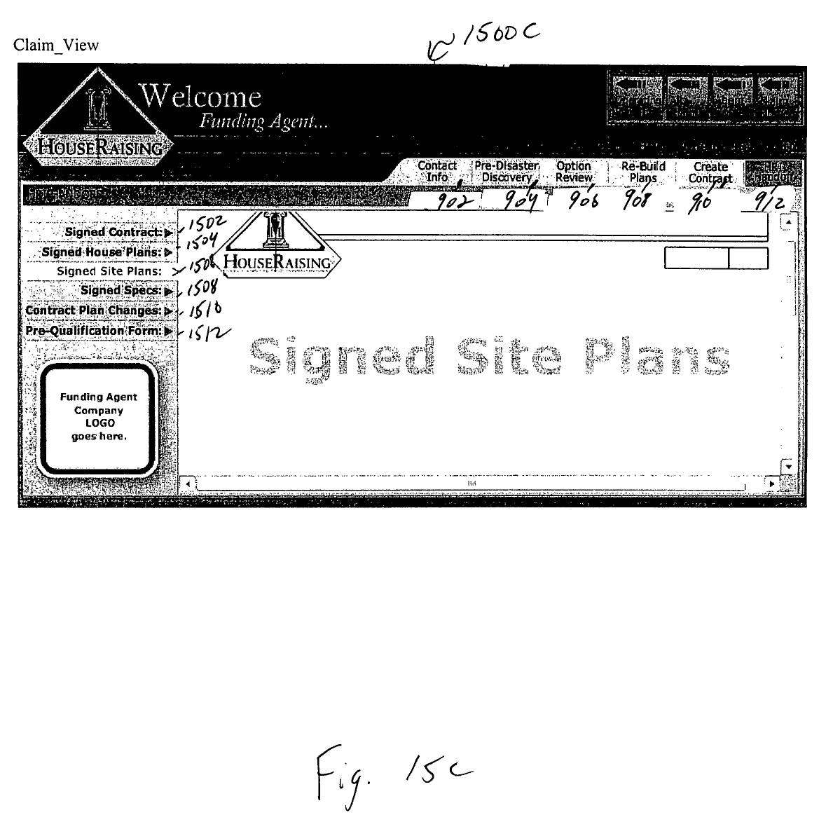

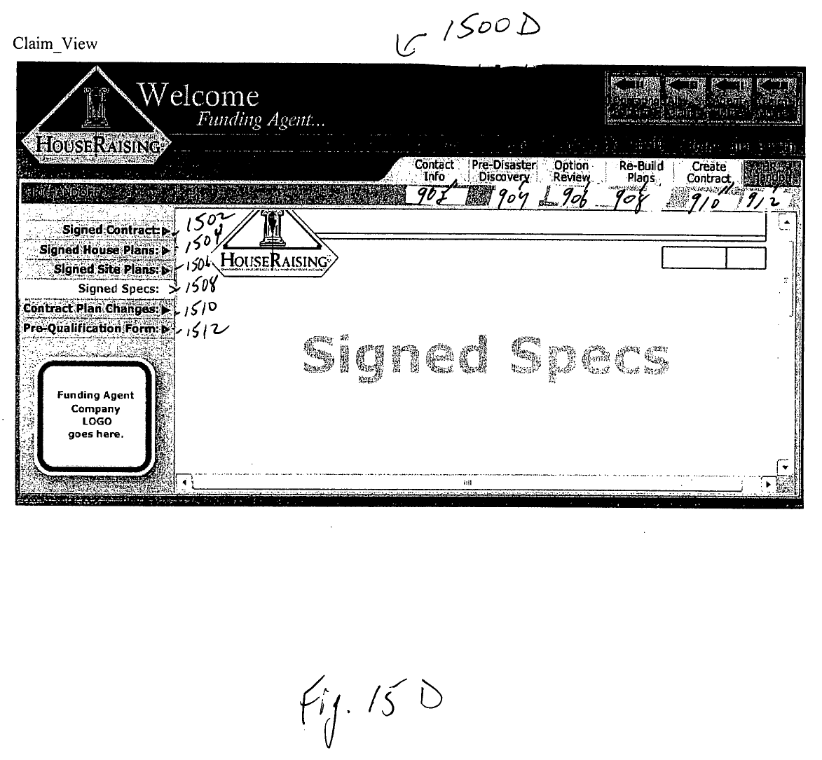

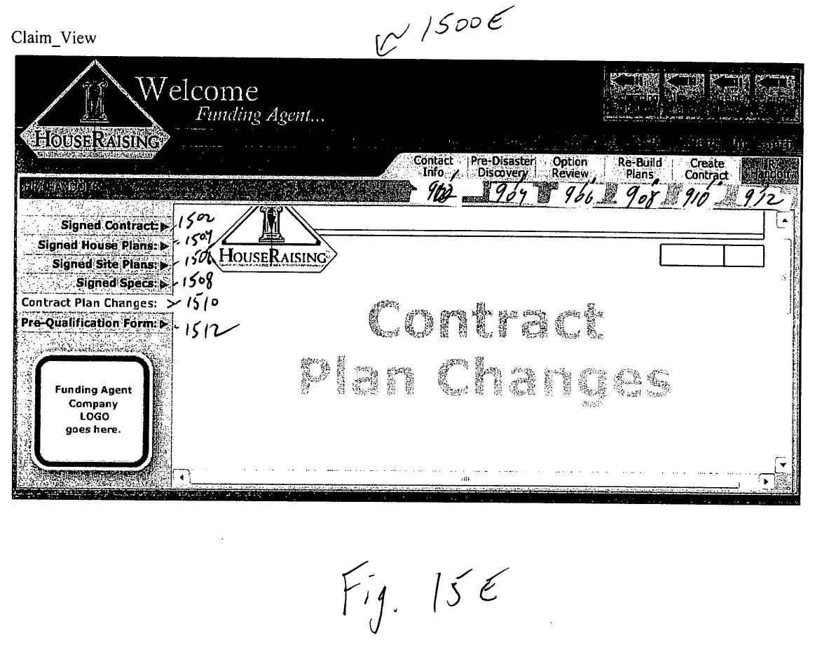

FIGS. 15A-15F illustrate example display screens provided for a user to submit and/or review various legal materials. For example, the documents include an executed sales contract agreement (display screen 1500A), an executed house plans agreement (display screen 1500B), an executed site plans agreement (display screen 1500C), an executed specifications agreement (display screen 1500D), an executed contract plan changes (display screen 1500E), and an executed borrower's pre-qualification agreement (display screen 1500F). The example displays screens 1500A-F illustrate an embodiment in which a user can confirm that various legal agreements have been executed prior to commencing on a building replacement project.

FIG. 15A illustrates an example display screen 1500A that is displayed to a user who selects Signed Contract side tab 1502. Once selected, a digital image of an executed sales agreement is displayed for the user.

FIG. 15B illustrates an example display screen 1500B that is displayed to a user who selects Signed House Plans side tab 1504. Once selected, a digital image of the signed copy of house plans is displayed for the user.

FIG. 15C illustrates an example display screen 1500C that is displayed to a user who selects Signed Site Plans side tab 1506. Once selected, a digital image of the signed copy of building site plans is displayed for the user.

FIG. 15D illustrates an example display screen 1500D that is displayed to a user who selects Signed Specs side tab 1508. Once selected, a digital image of the signed specs of the user's rebuilt building is displayed for the user.

FIG. 15E illustrates an example display screen 1500E that is displayed to a user who selects Contract Plan Changes side tab 1510. Once selected, a digital image of the revisions or changes to a contract plan is displayed for the user.

FIG. 15F illustrates an example display screen 1500F that is displayed to a user who selects Pre-Qualification side tab 1512. Once selected, a data entry display form if a mortgage prequalification form is provided for the user to submit details regarding the applicant in order to pre-qualify for a mortgage.

Thus, the present invention improves management of parties associated with rebuilding A benefit of the present invention is an ability to define and analyze a huge number of critical issues in a manner that serves the interest of all concerned parties. For example, the Federal Emergency Management Agency (“FEMA”), local governing parties and insurance agents are assured that issues that are being considered represent the facts as best they can be determined by a group of independent experts.

The present invention enables a prompt, accurate and improved system and method for gathering factual data in order to assess a destroyed or damaged building. In a preferred embodiment, the invention comprises an internet-based software application that enables a user to submit information related to insurance claims. Insurance companies, banks and government agencies can use the present invention to submit and review claims-related information, particularly for buildings.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for using a database to rebuild a damaged or destroyed building, the method comprising:
receiving from a user contact information representing a party owning the damaged or destroyed building, and storing the contact information in the database;
receiving from the user pre-damaged discovery information representing features of the damaged or destroyed building and features of a building site of the damaged or destroyed building, and storing the pre-damaged discovery information in the database;
receiving from the user replacement building information representing features for a replacement building that correspond with the damaged or destroyed building, and storing the replacement building information in the database;
receiving from the user foundation upgrade information representing a modification to the building site in case the party desires to modify the building site, and storing the foundation upgrade information in the database;
receiving from the user site inspection information representing observations made during a physical inspection of the building site of the damaged or destroyed building, and storing the site inspection information in the database;
receiving from the user financial information representing the financial status of the party and storing the financial information in the database;
modifying the replacement building information in the database representing a modified replacement building as a function of the foundation upgrade information, the site inspection information, and the financial information;
generating replacement building plan requirements as a function of the modified replacement building information; and
automatically generating a binding sales contract for the party and a builder for the replacement building.

2. The method of claim 1, further comprising submitting an insurance claim to an insurer for the damaged or destroyed building as a function of at least one of the pre-damaged discovery information, the replacement building information and the financial information.

3. The method of claim 1, further comprising automatically calculating financial costs associated with building the replacement building as a function of the pre-damaged discovery information, the foundation upgrade information, the financial information and the modified replacement building information.

4. The method of claim 1, further comprising storing building code information in the database representing building codes and determining whether the modified replacement building and the desired modification to the building site comply with building codes as a function of the building code information.

5. The method of claim 1, further comprising reviewing options representing costs of the replacement building, outstanding financial obligations of the party, insurance proceeds entitled to the party, cash proceeds of the party and funding options available to the party, and modifying the replacement building information as a function of the options.

6. The method of claim 1, wherein the modifying the replacement building information includes selecting a portfolio model corresponding to the pre-damaged discovery information.

7. The method of claim 6, further comprising designing a plan upgrade and applying the plan upgrade to the selected portfolio model.

8. A system for using a database to rebuild a damaged or destroyed building, the system comprising:
a contact module operable to receive from a user contact information representing a party owning the damaged or destroyed building, and to store the contact information in the database;
a pre-damaged discovery module operable to receive from the user pre-damaged discovery information representing features of the damaged or destroyed building and features of a building site of the damaged or destroyed building, and to store the pre-damaged discovery information in the database;
a replacement building module operable to receive from the user replacement building information representing features for a replacement building that correspond with the damaged or destroyed building, and to store the replacement building information in the database;
a user foundation upgrade module operable to receive from the user foundation upgrade information representing a desired modification to be made to the building site and to store the foundation upgrade information in the database;
a site inspection module operable to receive from the user site inspection information representing observations made during a physical inspection of the building site of the damaged or destroyed building, and to store the site inspection information in the database;
a financial information module operable to receive from the user financial information representing the financial condition of the party and to store the financial information in the database;
a modification module operable to modify the replacement building information in the database representing a modified replacement building as a function of the foundation upgrade information, the site inspection information, and the financial information;
a replacement building plans generator that generates replacement building plans as a function of the modified replacement building information; and
a binding sales contract generator operable to generate a sales contract for the party and a builder for the replacement building.

9. The system of claim 8, further comprising an insurance claim submission module operable to submit an insurance claim to an insurer for the damaged or destroyed building as a function of at least one of the pre-damaged discovery information, the replacement building information and the financial information.

10. The system of claim 8, further comprising a cost calculation module operable to calculate financial costs associated with building the replacement building as a function of the pre-damaged discovery information, the foundation upgrade information, the financial information and the modified replacement building information.

11. The system of claim 10, further comprising a building code module operable to store building code information in the database representing building codes and to determine whether the modified replacement building and the desired modification to the building site comply with building codes as a function of the building code information.

12. The system of claim 8, further comprising a review options module operable for reviewing options representing costs of the replacement building, outstanding financial obligations of the party, insurance proceeds entitled to the party, cash proceeds of the party and funding options available to the party, and for modifying the replacement building information as a function of the options.

13. The system of claim 8, wherein the modification module is further operable to select a portfolio model corresponding to the pre-damaged discovery information.

14. The system of claim 13, wherein the modification module is further operable to enable a user to design a plan upgrade and to apply the plan upgrade to the portfolio model.

15. A method for managing insurance proceeds for a party owning a damaged or destroyed building that was damaged or destroyed in connection with a damaged, the method comprising:
receiving from a user contact information representing the party owning the damaged or destroyed building, and storing the contact information in the database;
receiving from the user pre-damaged discovery information representing features of the damaged or destroyed building and features of a building site of the damaged or destroyed building, and storing the pre-damaged discovery information in the database;
receiving from the party insurance policy information representing an insurance policy associated with the damaged or destroyed building and issued by an insurance company, and storing the insurance policy information in the database;
submitting to the insurance company an insurance claim as a function of the contact information, the pre-damaged discovery information and the insurance policy information; and
receiving proceeds in connection with the claim and forwarding the proceeds to the party.
